(19) United States
(12) Patent Application Publication
(10) Pub. No.: US 2023/0351829 A1
(43) Pub. Date: Nov. 2, 2023

(54) INTERLOCK; SYSTEM, COMPRISING AN INTERLOCK; METHOD FOR CONTROLLING A FLOW OF PEOPLE AND/OR FOR SECURITY SCREENING; COMPUTER PROGRAM PRODUCT

(71) Applicant: dormakaba Deutschland GmbH, Ennepetal (DE)

(72) Inventor: Kai Weber, Ennepetal (DE)

(21) Appl. No.: 18/300,690

(22) Filed: Apr. 14, 2023

(30) Foreign Application Priority Data
Apr. 18, 2022 (EP) 22168688.4

(51) Int. Cl. G07C 9/10; G06V 40/10

(52) U.S. Cl. CPC G07C 9/10; G06V 40/10; G06V 2201/05

(57) ABSTRACT

An interlock, wherein the interlock includes an entrance and an inner region arranged behind the entrance, wherein the interlock has a body scanner and an optical playback device, wherein the body scanner is configured to scan a body of a person in the inner region of the interlock and wherein the playback device is configured to display a scanning position of the person, wherein the scanning position is suitable for successfully scanning the body of the person.

### CROSS-REFERENCE TO RELATED APPLICATIONS

This application claims the benefit of European patent application 22168688.4 filed 18 Apr. 2022, the disclosure of which is incorporated herein by reference in its entirety.

### TECHNICAL FIELD

The disclosure relates to an interlock, wherein the interlock comprises an entrance and an inner region arranged behind the entrance. Furthermore, the disclosure relates to a system comprising such an interlock, a method for controlling a flow of people and/or for security screening by means of an interlock, and a computer program product.

### BACKGROUND

Such interlocks are used, for example, at airports or train stations or as an access solution for a building or area. In order to increase the security of such facilities, security screening is carried out in which hazardous substances and/or weapons and/or objects that can be used as weapons should be detected. In this context, procedures for verifying the identity of people, for example at airports, often take place. One goal here is always to implement processes that are as secure as possible. The checks often lead to delays and are a limiting factor for the overall process in such facilities. On the other hand, high personnel requirements are typically necessary to carry out the checks and tests with a high level of security.

### SUMMARY

Against this background, the object is to provide an interlock, a system, a computer program product and a method with which a flow of people can be controlled and/or security screening can be carried out with a high level of security, wherein time delays and/or effort can preferably be reduced.

This is achieved by providing an interlock, wherein the interlock comprises an entrance and an inner region arranged behind the entrance, wherein the interlock has a body scanner and an optical, in particular electronic, playback device, wherein the body scanner is configured to scan a body of a person in the inner region of the interlock and wherein the playback device is configured to display a scanning position of the person, wherein the scanning position is suitable for successfully scanning the body of the person.

The scanning position can comprise a position of the person within the inner region and/or the posture of the person. In particular, the scanning position can comprise a frame within which the person has to position themselves in order to enable the body to be scanned successfully. The scanning position can be adjusted depending on the size and/or the contour and/or the position of the person.

According to the disclosure, a particularly advantageous interlock can thus be provided with which efficient detection of weapons and/or objects that can be used as weapons and/or hazardous substances is possible. This is possible without the need for security personnel to be positioned at the interlock to show people the correct position. This avoids delays during a security screening. As a result, wait times can be reduced, wherein an advantageous level of security can still be achieved.

The interlock is preferably designed as a person interlock with which a flow of people can be controlled and/or security screening can be carried out. In particular, at least the exit of the interlock can be closed such that people cannot pass through the interlock unhindered. Furthermore, the entrance of the interlock can preferably be closed.

An access solution for an area and/or a building, in particular for an airport and/or a train station, is preferably formed by means of the interlock. The interlock can be used to control and/or screen a flow of people into a closed-off region and/or a security region.

Advantageous further developments and configurations of the present disclosure can be inferred from the dependent claims.

The scanning position is preferably displayed in animated form. In other words, this takes place as an animation and/or moving image. In particular, an image of the person can be used as the beginning of the animation. In particular, an animation can be displayed moving towards the appropriate scanning position. In particular, the animation can end with the scanning position suitable for successful scanning, in particular wherein the suitable scanning position is derived from the image of the person and/or comprises a frame. This makes it easier for the person to understand what position to adopt, which can save time.

Preferably, the interlock comprises at least one separation sensor, wherein the separation sensor is configured to measure the number of people in the inner region of the interlock, preferably wherein the at least one separation sensor is designed as a 2D camera.

Thus, a particularly advantageous interlock can be provided with which an efficient detection of weapons and/or objects that can be used as weapons and/or hazardous substances and in particular at the same time a determination of the number of people in the interlock is possible. This is possible without the need for security personnel to be positioned at the interlock to guide people individually into the interlock or to monitor the number of people in the interlock. The separation sensor can be used to ensure that the body scanner scans a single person such that secure automated security screening can be achieved. This avoids delays during a security screening. As a result, wait times can be reduced, wherein an advantageous level of security can still be achieved.

According to one embodiment of the present disclosure, the fact that the separation sensor is configured to measure the number of people in the inner region of the interlock can be understood to mean that the separation sensor is configured in such manner that the separation sensor can be used to measure at least whether the number of people in the inner region of the interlock is exactly one. Thus, the separation sensor can be used to determine at least whether a single person is located in the inner region of the interlock. Preferably, the separation sensor can also be used to determine whether there is more than one person in the inner region of the interlock or whether there is less than one person in the inner region of the interlock. It is preferably conceivable that numbers of people greater than one in the inner region of the interlock can also be precisely determined by means of the separation sensor.

In particular, the separation sensor itself or the interlock can have an image processing unit, which processes the signal of the separation sensor. The signal can be transmitted in a wired or wireless manner.

Alternatively, the separation sensor can be designed as a time-of-light sensor or LiDAR sensor or stereo camera.

A time-of-light sensor is based on a time-of-flight measurement. A LiDAR sensor is based on a travel time measurement with, in particular, pulsed laser beams. In the case of the stereo camera, the environment is recorded simultaneously with two cameras, wherein the two cameras are arranged at a distance, in particular eye distance, from one another.

Preferably, at least one second separation sensor is arranged and, together with the separation sensor, is configured to capture a complete view, in particular a 360° view, of the person.

It is therefore not possible for another person to be hidden behind the person and for them not to be detected by the interlock. For this purpose, the signals of the two separation sensors are processed in one unit, in particular an image processing unit, in order to form the complete view. In particular, the second separation sensor can also be designed as a 2D camera or as a time-of-light sensor or LiDAR sensor or stereo camera. The second separation sensor can be arranged on an opposite side of the interlock. This enables the complete view to be made possible.

In particular, it can be provided that the separation sensor and/or the second separation sensor is/are arranged in a ceiling region of the interlock on a side wall of the interlock and/or in the inner region of the interlock, in particular in the center of the inner region of the interlock. The separation sensor is preferably arranged in such manner that the number of people in the inner region of the interlock can be checked by means of the separation sensor, in particular during the scan of the body scanner.

Alternatively or cumulatively, the separation sensor and/or the second separation sensor can be designed as an infrared sensor and/or an optical sensor, in particular by means of a camera.

Preferably, the number of people is measured and/or the scanning position of the person is displayed by means of an artificial intelligence system. In particular, the interlock can have the artificial intelligence system. The artificial intelligence system can be arranged in the interlock or close to the interlock or at a distance from the interlock.

According to one preferred embodiment of the present disclosure, it is possible that the artificial intelligence system has a machine learning system, a deep learning system, a neuronal network, contour detection and/or pattern detection. The artificial intelligence system is used for the reliable detection of individuals and/or the creation of a suitable, in particular as realistic as possible, display of the scanning position of the person.

Preferably, an image of the person currently located in the interlock is used to display the scanning position, in particular wherein the image takes into account a spatial position of the person and/or a size of the person and/or a contour of the person and/or the actual appearance of the person, in particular in a faded-out or blurred form. In particular, the image can be scaled to a standard size. The image preferably has, at least in regions, one or a plurality of marked body regions, wherein the marked region indicates to the person whether the position is correct. The marking can be done, for example, by color markings. Alternatively or cumulatively, a status notification can be emitted, in particular as a color marking, preferably by means of the playback device and/or the other playback device, wherein the status notification indicates whether the scanning position has been adopted.

In this way, an appropriate display is possible. The person can thus be encouraged in an interactive and targeted manner to move into the correct scanning position. Thus, the efficiency of the interlock is improved.

In particular, the artificial intelligence system can be used to create the image.

Preferably, the inner region is recorded by means of the at least one separation sensor after the person has exited the interlock directly and/or indirectly, wherein the recording is compared with a reference recording.

In this case, the reference recording can be stored within a database or, in particular, can be recorded periodically. In particular, it can be thereby determined whether the person has forgotten an object within the inner region. If a difference is determined during the comparison, a signal can also be output to security personnel and/or to the person by means of the interlock, in particular by means of the playback device and/or another playback device, and/or an external source. In this way, an automatic signal can be emitted to remind people of forgotten items. It can preferably be determined by means of the separation sensor, in particular by means of the artificial intelligence system, what kind of object, for example a rucksack, suitcase or shoe, is involved.

Preferably, the entrance also serves as an exit or the exit is arranged opposite or to the side of the entrance.

In particular if the entrance also serves as an exit, the interlock can only be entered and exited through the entrance. The interlock can otherwise be closed. Alternatively, a separate exit can be arranged, but this is permanently blocked.

According to one embodiment of the present disclosure, it is provided that the interlock has an entrance door device at the entrance of the interlock, wherein the entrance door device can be used to close and open the entrance, wherein the interlock has an exit door device at the exit of the interlock, wherein the exit door device can be used to close and open the exit.

In the event that the entrance also serves as an exit, the entrance door device can also serve as an exit door device.

It is in particular conceivable that the entrance door device comprises a sliding door, in particular an automatic sliding door, and/or a swing door, in particular an automatic swing door.

It is conceivable that the interlock comprises a pivotable and/or rotatable door device, wherein the door device is pivotable and/or rotatable at least between a first position and a second position, wherein, in the first position, the exit is closed by means of the door device and the entrance is opened, wherein, in the second position, the entrance is closed by means of the door device and the exit is opened. According to a preferred configuration, it is conceivable that there is an intermediate position in which both the entrance and the exit are closed by means of the pivotable and/or rotatable door device. It is preferably conceivable that the door device is in this intermediate position during the scan by means of the body scanner and during the measurement by means of the separation sensor such that both the entrance and the exit are closed. In a particularly advantageous manner, the interlock can therefore have a rotatable door device with at least one opening which, depending on its rotational position, closes:
the entrance, or
the exit, or
both the entrance and the exit.

It is optionally conceivable that the door device has a rotational position in which both the entrance and the exit are open, in particular in the event that the entrance also serves as an exit.

Alternatively or additionally, it is conceivable according to one embodiment of the present disclosure that the entrance door device and/or the exit door device and/or the pivotable and/or rotatable or displaceable door device comprises one or a plurality of the following devices:
a hinged door,
a revolving door,
a security revolving door,
a bifold door,
a tripod turnstile,
a turnstile,
a pivot door.

According to one embodiment of the present disclosure, it is provided that the body scanner is configured to detect dangerous objects on the body of the person and/or on the clothing of the person. In this context, dangerous objects can be understood to mean, for example, weapons and/or objects that can be used as weapons and/or other hazardous substances. The body scanner is preferably a full body scanner. In particular, it can be provided that the body scanner is configured to scan the body of the person by means of X-rays and/or terahertz radiation. Such a body scanner can also be used to effectively detect concealed dangerous objects, for example underneath clothing.

According to one embodiment of the present disclosure, it is provided that the separation sensor and the body scanner are configured in such manner that a measurement of the separation sensor and a scan of the body scanner are carried out directly or indirectly one after the other or at least partially simultaneously. In particular, this can be done by means of an, in particular electronic, control device. Electrical circuit means, in particular computer-implemented means, are preferably present, which actuate the separation sensor and the body scanner in such manner that a measurement of the separation sensor and a scan of the body scanner are carried out directly or indirectly one after the other, preferably without an intervening pause, or partially simultaneously or completely simultaneously. A particularly high level of security can thus be achieved. It is thereby particularly advantageously conceivable that the measurement of the separation sensor and the scan of the body scanner are carried out partially or completely simultaneously such that it is ensured that the number of people in the interlock is known during the scan with the body scanner. As a result, deceptions can be prevented in a particularly advantageous manner without security personnel having to be stationed at the interlock at all times in order to monitor the number of people in the body scanner during the scan. At least the exit of the interlock is preferably closed during the scan by means of the body scanner and during the measurement by means of the separation sensor. It is preferably possible for both the entrance and the exit of the interlock to be closed during the scan by means of the body scanner and during the measurement by means of the separation sensor.

Alternatively or cumulatively, the interlock can be configured to carry out the following method, in particular in the order listed:
the entrance is open or will be opened,
   the person, in particular the single person, enters the interlock,
   in particular measurement of the number of people,
   the entrance is closed, preferably if a single person was measured, otherwise a warning message and/or error message, in particular by means of the playback device and/or another playback device
   preferably: measurement of the number of people, preferably if not already previously carried out,
   display of the scanning position, preferably if a single person was measured, otherwise warning message and/or error message,
   in particular waiting for the person to adopt the scanning position,
   preferably detection of the scanning position by means of the separation sensor, particularly preferably by means of the artificial intelligence system,
   preferably automatic triggering of the scan of the body of the person by means of the body scanner directly or indirectly after the detection of the scanning position,
   scan of the body of a person, preferably after the scanning position has been adopted,
   opening the exit.

Depending on whether dangerous objects have been identified, the person can exit the interlock, hand over the objects and enter the interlock again, or exit the interlock region without being regarded as posing a danger. Such a method is also an aspect of the disclosure. Thus, an optimal energy consumption of the interlock can be made possible. In this way, unnecessary scanning processes are avoided.

Unnecessary closing processes can be avoided by means of measuring the number of people before the entrance is closed. By displaying the scanning position only if a single person has been measured, the single person can be quickly signaled what to do next. By waiting forthe person to adopt the scanning position, the scan can only be triggered when the scanning position has been adopted such that unnecessary scanning processes are avoided. The scanning position can be reliably determined by detecting the scanning position by means of the separation sensor, in particular by means of the artificial intelligence system. The method can be further automated by automatically triggering the scan of the body of the person by means of the body scanner directly or indirectly after the scanning position has been detected. This enables a quick process, in particular without personnel.

Another subject matter of the present disclosure is a system, comprising at least one interlock according to one embodiment of the present disclosure, wherein the system additionally has a front region arranged in front of the entrance of the interlock, wherein the front region can be entered through an access device,

wherein at the access device or in the vicinity of the access device is arranged
a sensor device and/or
an identity checking device and/or
a ticket checking device,
   by means of which people entering the front region can be checked.

In this way, a system is created that enables controlled and secure access with little personnel effort and a high level of security.

In particular, the sensor device can be designed as a 2D camera or as a time-of-light sensor or LiDAR sensor or stereo camera. The sensor device can preferably be configured for separating and/or counting people.

People entering the front region can preferably be counted by means of the access device,
wherein the system is configured in such manner that:
   a count of the people entering the front region is carried out by means of the sensor device and/or the identity checking device and/or the ticket checking device,
   another count of the people exiting the front region through the interlock is carried out by means of the interlock, in particular by means of the separation sensor of the interlock,
   the number of people within the front region is determined and/or monitored by means of the count and the further count.

The sensor device at the access device or in the vicinity of the access device is designed, for example, by means of an infrared sensor and/or an optical sensor, for example a camera. The sensor device can in particular be designed as a further separation sensor.

According to a preferred embodiment of the present disclosure, it is conceivable that, at the access device of the front region and/or in the vicinity of the access device of the front region, an identity check by means of the identity checking device and/or a ticket check by means of the ticket checking device is carried out for people entering the front region through the access device. It is conceivable that the access device opens, in particular exclusively, when an identity check carried out by means of the identity checking device and/or a ticket check carried out by means of the ticket checking device is successful such that a person can only enter the front region if the identity check and/or ticket check has been successful. The identity checking device is designed, for example, to detect and/or check a passport document. The ticket checking device is designed, for example, to detect and/or check a plane ticket and/or train ticket.

It is alternatively or additionally conceivable for the identity checking device to have one or a plurality of biometric sensors, for example for facial recognition or fingerprint recognition. The at least one sensor is preferably designed as a camera. The identity checking device is preferably configured in such manner that it carries out facial recognition and/or contour recognition. In this way, people entering the front region, in particular without a ticket or the like, can be checked, in particular with regard to their identity, and/or counted. This can be done cumulatively by means of the artificial intelligence system or another artificial intelligence system. In this way, a high level of security is made possible with few personnel requirements. It is conceivable that each successful identity check and/or successful ticket check is counted such that the identity check and/or the ticket check is used to count the people entering the front region. It is conceivable that this count, which is carried out by means of the identity check and/or the ticket check, is compared with the further count, wherein the further count is carried out by means of the interlock, in particular by means of the separation sensor of the interlock, and wherein the further count relates to at least the people exiting the front region through the interlock. A number of people within the front region can thus be determined and/or monitored by way of the count by means of the identity check and/or the ticket check and by way of the further count by means of the interlock. It can also be determined whether the total number of people who have entered the front region through the access device corresponds to the number of people who have exited the front region via the interlock. A particularly high level of security can be achieved in this way. It is possible in a particularly advantageous manner to implement a permanent comparison between the number of people entering and exiting.

According to a preferred embodiment of the present disclosure, the front region has a barrier and/or wall and can be entered during normal operation, preferably exclusively through the access device and/or other access devices. The interlock, which can also establish a connection between the front region and an environment, is preferably set and/or operated in such manner that entry from the environment into the front region through the interlock is prevented during normal operation. The front region is therefore preferably not accessible via the interlock during normal operation of the interlock.

According to a preferred embodiment of the present disclosure, it is conceivable that a baggage conveyor means, in particular a baggage carousel, is arranged in the front region or adjacent to the front region. It is conceivable that a person with their baggage enters the front region through the access device and places their baggage on the baggage conveyor means there. The person then moves into the interlock without the baggage that they presented. After successfully passing through the interlock, the person can retrieve their baggage again. The baggage is preferably examined and/or checked when it is being conveyed by means of the baggage conveyor means, in particular by means of an additional sensor device that is configured to identify dangerous objects and/or hazardous substances in the baggage.

Alternatively or cumulatively, the front region can have an exit device. Preferably, the exit device can be arranged in the case where the entrance of the interlock also serves as an exit. At the exit device or in the vicinity of the exit device,
another sensor device and/or
another identity checking device and/or
another ticket checking device
   can be arranged, by means of which people exiting the front region can be checked.

In this way, a system is created that enables controlled and secure access with little personnel effort and a high level of security.

Alternatively or cumulatively, in the event that the entrance of the interlock also serves as an exit, the access device can be designed in such manner that the people exiting the interlock can exit the front region again by means of the access device. In this case, the access device can be designed to be accessible in both directions. In this case, it is conceivable that the people exiting the interlock can also be counted by means of the access device. In this way, the number of people within the front region can also be counted.

In particular, the further sensor device and/or the further identity checking device, preferably designed as a camera, can be configured in such manner so as to carry out facial recognition and/or contour recognition and/or fingerprint recognition. In this way, people exiting the front region, in particular without a ticket or the like, can be checked, in particular with regard to their identity, and/or counted. This can be done by means of the artificial intelligence system or another artificial intelligence system. In this way, a high level of security is made possible with few personnel requirements.

People exiting the front region can preferably be counted by means of the exit device,
wherein the system can be configured in such manner that:
   a count of the people entering the front region is carried out by means of the sensor device and/or the identity checking device and/or the ticket checking device,
   another count of the people exiting the front region through the interlock is carried out by means of the interlock, in particular by means of the separation sensor of the interlock, and/or
   a second count of the people exiting the front region through the interlock is carried out by means of the exit device, in particular by means of the additional sensor device,
   a number of people within the front region is determined and/or monitored by means of the count and the further count and/or the second count.

Alternatively or cumulatively, the system can comprise a control sensor device that tracks the people, in particular continuously, at least within the system. The control sensor device can comprise one or a plurality of control sensors, in particular designed as a camera, which can be arranged distributed in the system. In particular, the people can be continuously tracked by means of the artificial intelligence system or a global artificial intelligence system, in particular based on facial recognition and/or contour recognition. In this way, the flow of people can be reliably monitored, at least within the system.

If the arrangement of the exit device is present, the people exiting the region can be checked and/or counted by means of such a control sensor device as an alternative or in addition to the further sensor device and/or the further identity checking device and/or the further ticket checking device. This is made possible because the people are continuously tracked by means of the control sensor device.

A global count of the number of people within the front region can preferably be carried out by means of the control sensor device.

In this way, the flow of people can be reliably monitored, at least within the system.

In particular, the interlock and/or the system can have another playback device. It is conceivable that the other playback device is arranged in such manner that a warning message, in particular a warning message relating to the determination of a dangerous object by means of the body scanner, cannot be perceived from the inner region of the interlock. This can be advantageous, for example, in order to give the security personnel a head start in terms of time and/or information with respect to a person in the interlock who is carrying a dangerous object. The other playback device preferably comprises an optical playback device, in particular a screen. It is additionally or alternatively conceivable that the other playback device is arranged in such manner that a warning message can be perceived from the inner region of the interlock.

In particular, the playback device and/or the other playback device can signal to the person within the interlock in a visual and/or acoustic manner what is necessary, in particular additionally, for successful scanning and/or which actions the person must carry out in order to ensure successful scanning. The signal can relate to the number of people and/or to existing dangerous objects, in particular their location. In particular, the location of the dangerous objects can be displayed on the image of the person by means of the playback device.

It is conceivable that the system is configured in such manner that a warning message can be emitted by means of the playback device and/or the other playback device depending on the measurement of the number of people by means of the separation sensor and/or depending on the scan of the body by means of the body scanner. The warning message preferably signals that a dangerous object has been detected and/or includes additional information on the detected dangerous object, for example what type of dangerous object it is and/or at which location the dangerous object is being carried by the person in the interlock. Additionally or alternatively, the warning message signals that there is more than one person in the interlock.

For example, it is possible that the playback device and/or the other playback device can be used to signal to people in the interlock that there are too many people in the inner region of the interlock if the separation sensor detects that there is more than one person in the inner region of the interlock. It is conceivable, for example, that the other playback device is designed partially or completely as part of the interlock.

Another subject matter of the present disclosure is a method for controlling a flow of people and/or for security screening by means of an interlock according to an embodiment of the present disclosure or by means of a system according to an embodiment of the present disclosure, wherein the method comprises the following steps, in particular in the order listed:
display of the scanning position,
a body of a person in the inner region of the interlock is scanned by means of the body scanner.

In this way, a time
and/or energy-efficient and secure screening of people and/or control of a flow of people can take place.

In particular, the two steps can be carried out directly or indirectly one after the other or at least partially simultaneously.

In particular, the method comprises a step:
the number of people in the inner region of the interlock is measured by means of a separation sensor.

It is conceivable that this step is carried out before and/or indirectly and/or directly one after the other and/or at least partially simultaneously with the steps:
display of the scanning position and/or,
a body of a person in the inner region of the interlock is scanned by means of the body scanner.

In this way, an efficient and secure screening of people and/or control of a flow of people can take place. In particular, it is possible to dispense with the deployment of security personnel who are specifically intended to indicate the scanning position to people and/or to guide them individually into a body scanner.

The method according to the disclosure is in particular a computer-implemented method, in which one, a plurality of, or all the steps of the method are carried out by computer. In particular, the individual components of the interlock and/or of the system are actuated by computer.

According to a preferred embodiment of the present disclosure, it is possible that, before the body is scanned by means of the body scanner, in particular before the number of people is measured by means of the separation sensor:
at least one person moves through the open entrance into the interlock, preferably while the exit of the interlock is closed,
optional: the entrance of the interlock is closed after the at least one person has moved through the open entrance into the interlock.

Alternatively or cumulatively, it is conceivable that, before the body is scanned by means of the body scanner, the following takes place:
a single person has been measured within the interlock by means of the separation sensor, preferably while the exit of the interlock is closed,
in particular wherein the entrance of the interlock is closed after the single person has been measured,
in particular wherein the scanning position has been displayed,
in particular wherein the person has adopted the scanning position.

In particular, the described artificial intelligence system can be used to check whether the scanning position has been adopted.

In this way, the energy consumption of the interlock can be reduced, since as many errors as possible are avoided before the energy-intensive scanning.

According to a preferred embodiment of the present disclosure, it is possible that the exit of the interlock is opened, depending on the measurement of the number of people by means of the separation sensor and/or depending on the scan of the body by means of the body scanner. The exit of the interlock is preferably closed during the measurement by means of the separation sensor and during the scan by means of the body scanner by way of an exit door device or a pivotable and/or rotatable door device. The exit of the interlock is preferably opened by means of the exit door device or the pivotable and/or rotatable door device depending on the measurement of the number of people by means of the separation sensor and depending on the scan of the body by means of the body scanner. A particularly advantageous control of the flow of people can thus be achieved without the need for security personnel to be continuously present in the region of the body scanner in order to control the flow of people into and out of the body scanner.

In the event that the entrance also serves as an exit, the interlock can be configured to carry out the following method, in particular in the order listed:
the entrance is open or will be opened,
the person, in particular the single person, enters the interlock,
in particular measurement of the number of people,
the entrance is closed, preferably if a single person has been measured, preferably otherwise: warning message and/or error message,
in particular measurement of the number of people, preferably if not already previously carried out,
display of the scanning position, preferably if a single person has been measured, preferably: otherwise warning message and/or error message,
in particular waiting for the person to adopt the scanning position,
preferably detection of the scanning position by means of the separation sensor, particularly preferably by means of the artificial intelligence system,
preferably automatic triggering of the scan of the body of the person by means of the body scanner directly or indirectly after the detection of the scanning position,
scan of the body of a person, in particular after the scanning position has been adopted,
opening the exit.

Depending on whether dangerous objects have been detected, the person can hand them in and re-enter the interlock or exit the interlock region without being regarded as posing a danger.

According to a preferred embodiment of the present disclosure, it is possible that the display of the scanning position by means of the playback device and the scan of the body by means of the body scanner are carried out indirectly and/or directly one after the other and/or at least partially simultaneously. This enables an efficient process.

Preferably, it is possible
that the display of the scanning position and/or the measurement of the number of people by means of the separation sensor and the scan of the body by means of the body scanner are carried out, preferably at least partially simultaneously, while an exit of the interlock is closed.

The entrance can also serve as an exit or the exit can be arranged opposite or to the side of the entrance. This allows a high level of security to be made possible.

Furthermore, in the event that the exit is located opposite or to the side of the entrance:
the exit of the interlock will only be opened if:
the measurement of the number of people by means of the separation sensor shows that there is a single person in the inner region of the interlock, and in addition
the scan of the body by means of the body scanner shows that the person in the inner region of the interlock is not carrying any dangerous objects.

In the event that the exit is arranged opposite or to the side of the entrance, it is possible in a particularly advantageous manner for the entrance of the interlock to be opened only when and/or after a person who has been scanned by means of the body scanner exits the interlock such that the next person can enter the interlock. In this way, an advantageous level of security can be achieved.

According to a preferred embodiment of the present disclosure, it is possible that
in the event that the measurement of the number of people by means of the separation sensor shows that there is more than one person in the inner region of the interlock, and/or
in the event that the scan of the body by means of body scanner shows that a person in the interlock is carrying at least one dangerous object, the exit remains closed and optionally a warning message is emitted by means of the playback device and/or the other playback device.

Another subject matter of the present disclosure is a computer program product, wherein the computer program product comprises commands which, when the computer program product is executed by a computer, in particular a preferably electronic control device of the interlock and/or of the system, cause the computer to carry out a method according to an embodiment of the present disclosure. The computer is preferably partially or fully designed as part of the interlock and/or partially or fully designed externally to the interlock. The computer is preferably designed to actuate the separation sensor and the body sensor, as well as the entrance door device, the exit door device and/or the pivotable and/or rotatable door device. It is conceivable that the computer is a single computer device or that the computer comprises a plurality of distributed computer devices. The plurality of computer devices can in particular be arranged at different locations, for example partially as part of the interlock and partially as part of a monitoring device for the security personnel.

Another subject matter of the present disclosure is a computer-readable storage medium comprising a computer program product according to an embodiment of the present disclosure.

The features, embodiments and advantages, which have already been described in connection with the interlock according to the disclosure or in connection with one embodiment of the interlock according to the disclosure, can thereby be applied to the system according to the disclosure, the method according to the disclosure, the computer program product according to the disclosure and the computer-readable storage medium according to the disclosure. The features, embodiments and advantages, which have already been described in connection with the system according to the disclosure or in connection with one embodiment of the system according to the disclosure, can thereby be applied to the interlock according to the disclosure, the method according to the disclosure, the computer program product according to the disclosure and the computer-readable storage medium according to the disclosure. The features, embodiments and advantages, which have already been described in connection with the method according to the disclosure or in connection with one embodiment of the method according to the disclosure, can thereby be applied to the interlock according to the disclosure, the system according to the disclosure, the computer program product according to the disclosure and the computer-readable storage medium according to the disclosure.

### BRIEF DESCRIPTION OF THE DRAWINGS

Further advantages and details of the disclosure will be explained below on the basis of the exemplary embodiments represented in the figures. They show:

FIG. 1 a representation of an interlock according to a first exemplary embodiment of the present disclosure;

FIG. 2 a representation of an interlock according to a second embodiment of the present disclosure; and

FIG. 3 a schematic representation of a system according to one exemplary embodiment of the present disclosure.

### DETAILED DESCRIPTION OF THE DRAWINGS

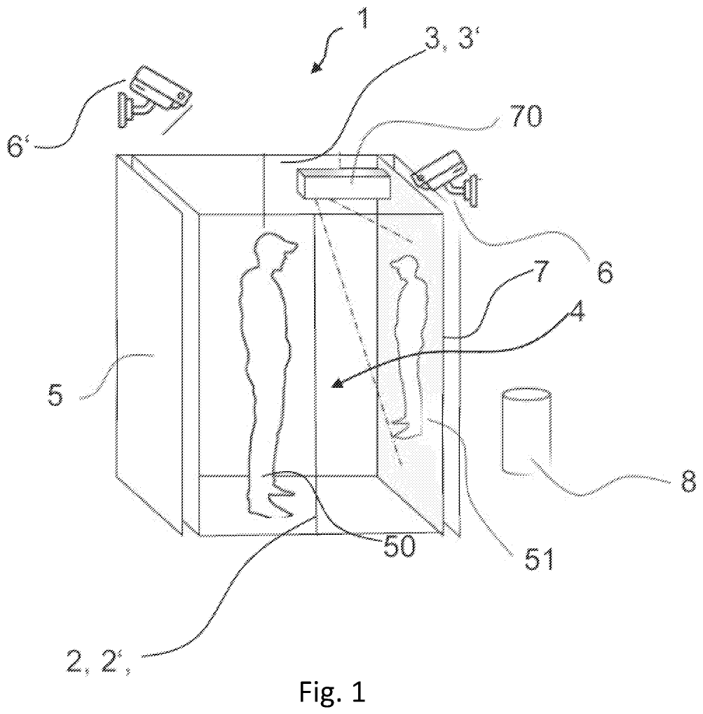

The interlock 1 according to FIG. 1 comprises an entrance 2 with an entrance door device 2′, an exit 3 with an exit door device 3′, an inner region 4 and a body scanner 5. Furthermore, the interlock 1 comprises a playback device 7 having the projector 70. Furthermore, the interlock 1 has two separation sensors 6, 6′. Furthermore, an image processing unit and an artificial intelligence system are represented combined as 8. A person 50 is standing in interlock 1. They are detected by means of the separation sensors 6, 6′. An image 51 of the person 50 is shown by means of the playback device 7. Since the person obviously adopts a position that is not suitable for scanning, the scanning position based on the image 51 would be shown by means of the playback device 7 in the next step, not shown. The image processing unit and the artificial intelligence system 8 determine and create the image 51 and the scanning position based on the image 51. In this way, the person is encouraged in an interactive manner to adopt the scanning position such that the scan can take place successfully.

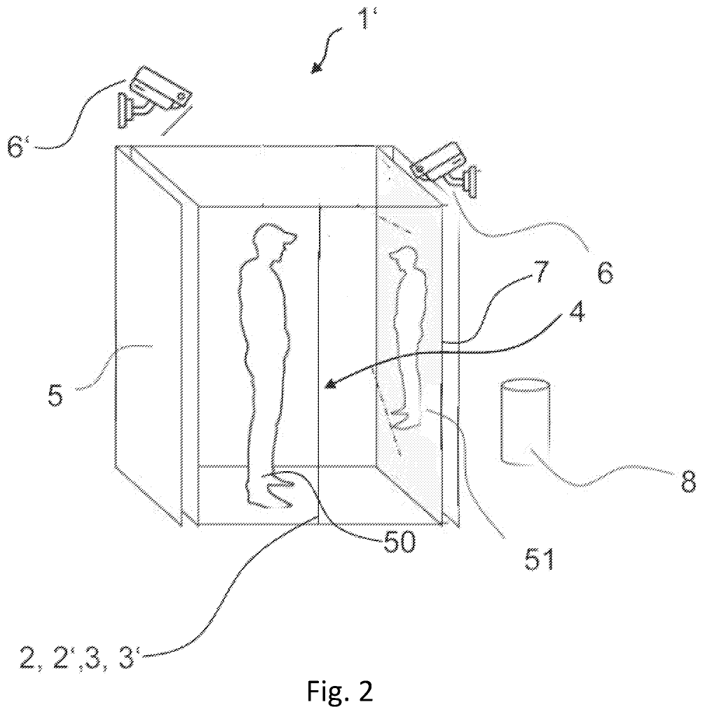

The interlock 1′ according to FIG. 2 differs from the interlock 1 according to FIG. 1 in that the entrance 2 also serves as an exit 3 and therefore the entrance door device 2′ also serves as an exit door device 3′, as well as by the playback device 7 designed as an LED display. Otherwise, the interlock is designed to be closed.

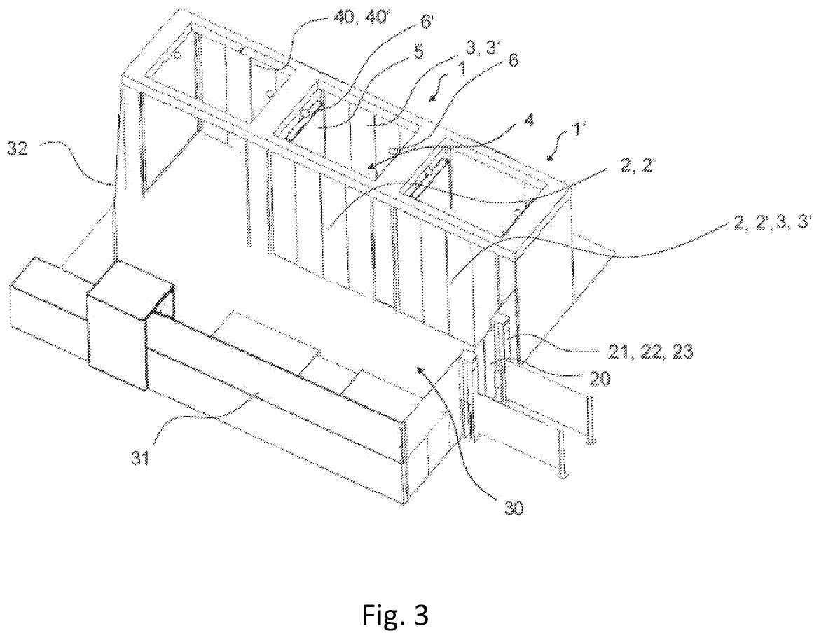

The system according to FIG. 3 comprises an interlock 1, by means of which a flow of people can be controlled and security screening can be carried out. A front region 30 is arranged in front of the interlock 1. A person can go from the front region 30 through the entrance 2 of the interlock 1 into the inner region 4 of the interlock 1. The entrance 2 is equipped with an entrance door device 2′, in particular a sliding door. The entrance 2 can be opened and closed by the entrance door device 2′. A person scanner 5 is arranged in the interlock 30 1, which enables a body scan of a person, who is located in the inner region 4 of the interlock 1, preferably by means of X-rays and/or terahertz radiation. The interlock 1 also comprises separation sensors 6, 6′, which are arranged in a ceiling region of the interlock 1 in the represented exemplary embodiment and with which it can be determined whether a single person is located in the inner region 4 of the interlock 1. Furthermore, the interlock 1 comprises an exit 3 with an exit door device 3′. People who have been scanned can step out of the inner region 4 of the interlock 1 through the exit 3 and thus, for example, enter a security region of an airport, a train station or another building. The exit 3 of the interlock 1 can be opened and closed by means of the exit door device 3′.

Furthermore, in the exemplary embodiment shown, another interlock 1′ 5 according to FIG. 2 is arranged adjacent to the front region 30, purely by way of example. The other interlock 1′ can only be exited in the direction of the front region. In the case of the arrangement of such an interlock 1′, an exit device not shown would therefore have to be arranged, for example in the region of the barrier 32 such that the people from the interlock 1′ can exit the front region 30 again. Alternatively, it is possible for these people to be able to exit the front region 30 again by means of the access device 20 if the access device 20 is designed so as to be accessible in both directions.

There is also an exit region 40 for the front region 30. The exit region 40 is closed by means of a door device 40′ and can be opened if necessary, for example for people for whom the interlocks 1, 1′ are not suitable for physical or medical reasons. The front region 30 is a region that is closed off from the environment by means of a barrier 32 and can be entered through an access device 20. The access device 20 is configured in such manner that it can enable and block access to the front region 30. For example, the access device 20 20 comprises one or a plurality of pivoting door leaves for this purpose. Alternatively, other door types are also conceivable. A sensor device 23 and/or an identity checking device 22 and/or a ticket checking device 21 is arranged at the access device 20. It is conceivable that the access device 20 grants a person access to the front region 30 if a ticket check has been carried out by means of the ticket checking device 21 and/or an identity check has been carried out by means of the identity checking device 22. In this way, access to the front region 30 can be granted in a controlled manner. On the one hand, it can be ensured that only one person passes through the access device 20 per ticket check and/or identity check. On the other hand, this makes it possible to 30 count or limit the number of people within the front region 30 and/or the interlocks 1, 1′ and/or the exit region 40. In particular, the opening of the access device 20 could be blocked at least temporarily if the number of people within the mentioned systems exceeds a certain number. Furthermore, in the front region 30 there is a baggage conveyor means 31, in particular a baggage carousel, on which a person in the front region 30 can place their baggage, including any items they are carrying, before the person enters the interlock 1.

According to an exemplary embodiment of a method according to the disclosure, a person passes the access device 20 and thus reaches the front region 30. Passage through the access device 20 is counted by means of the sensor device 23 and/or the identity checking device 22 and/or the ticket 5 checking device 21. In the front region 30, the person places their baggage on the baggage conveyor means 21. If there is no person in the interlock 1, the interlock 1 is in a state in which its exit 3 is closed, for example by means of the exit door device 3′, and in which its entrance 2 is open. The person enters the inner region 4 of the interlock 1 through the entrance 2. The entrance 2 of the interlock 1 is closed, for example by means of the entrance door device 2′. It is conceivable that the entrance 2 is closed as a function of a detection by the separation sensor 6, in particular when the separation sensor 6 detects that the person has entered the inner region 4. A body scan by means of the body scanner 5 is carried out for the person located in the inner region 4. Preferably, at the same time as the body scanner 5 scans, the separation sensor 6 is used to check that there is a single person in the inner region 4 of the interlock 1. If the body scan and the measurement of the separation sensor 6 indicate that there is a single person in the inner region 4 and that the person is not carrying any dangerous objects, the exit 3 opens such that the person can exit the interlock through the exit. Otherwise, if more than one person is detected in the inner region 4 or the body scan detects a dangerous object, the exit 3 does not open. Instead, a warning message and/or error message is preferably displayed, for example to security staff and/or to the person(s) in interlock 1. If, for example, it was detected that more than one person is in the inner region 4 of the interlock 1, an acoustic and/or visual warning message can be emitted, which prompts the people in the inner region 4 of the interlock 1 to exit the interlock 1 through the entrance 3 until only one person is in the inner region 4. If a dangerous object has been detected by means of the body scanner 5, at least the security personnel will be informed by means of the warning message such that they can initiate further checks or countermeasures. A particularly advantageous automation can thus be achieved, with which time can be saved. At the same time, it can be avoided that security personnel must be present at every body scanner to monitor and control the flow of people into and out of the body scanner.

The successful passage of a person through the interlock 1 can be counted, for example by means of the opening of the exit 3, the measurement of the body scanner 5 and/or the measurement of the separation sensor 6. This further count can be compared with the count carried out by means of the sensor device 23 and/or the identity checking device 22 and/or the ticket checking device 21. In this way, for example, it can be monitored whether the number of people entering the front region 30 corresponds to the number of people exiting the front region 30. As a result, a particularly advantageous and automatable additional security check can be set up. Furthermore, this makes it possible to limit the number of people within the front region 30 and/or the interlocks 1, 1′ and/or the exit region 40.

1. An interlock, wherein the interlock comprises an entrance and an inner region arranged behind the entrance, wherein the interlock has a body scanner and an optical playback device, wherein the body scanner is configured to scan a body of a person in the inner region of the interlock and wherein the playback device is configured to display a scanning position of the person, wherein the scanning position is suitable for successfully scanning the body of the person.

2. The interlock according to claim 1, wherein the scanning position is displayed in animated form.

3. The interlock according to claim lone of the preceding claims, wherein the interlock comprises at least one separation sensor, wherein the separation sensor-is configured to measure a number of people in the inner region of the interlock, wherein the at least one separation sensor-is designed as a 2D camera.

4. The interlock according to claim 1, wherein at least one second separation sensor is arranged and, together with the separation sensor, is configured to capture a complete view in particular a 360° view, of the person.

5. The interlock according to claim 1, wherein the number of people is measured and/or the scanning position of the person is displayed by means of an artificial intelligence system.

6. The interlock according to claim 1, wherein an image of the person currently located in the interlock is used to display the scanning position, wherein the image shows a spatial position of the person and/or a size of the person and/or a contour of the person and/or the actual appearance of the person.

7. The interlock according to claim 3, wherein the at least one separation sensor is used to record the inner region after the person has exited directly and/or indirectly, wherein the recording is compared with a reference recording.

8. The interlock according to claim 3, wherein the separation sensor and the body scanner are configured in-such that a measurement of the separation sensor and a scan of the body scanner take place directly or indirectly one after the other or are carried out at least partially simultaneously.

9. The interlock according to claim 1, wherein the entrance also serves as an exit or wherein the exit is arranged opposite or to the side of the entrance.

10. The interlock according to claim 1, wherein the body scanner is configured to detect dangerous objects on the body of the person and/or on the clothing of the person.

11. A system, comprising at least one interlock according to claim 1, wherein the system additionally has a front region arranged in front of the entrance of the interlock, wherein the front region can is configured to be entered through an access device, wherein at the access device or in the vicinity of the access device is arranged
a sensor device and/or
an identity checking device and/or
a ticket checking device,
by which people entering the front region are configured to be checked.

12. The system according to claim 11, wherein people entering the front region are configured to be counted by means of the access device,
wherein the system is configured such that:
a count of the people entering the front region is carried out by the sensor device and/or the identity checking device and/or the ticket checking device,
another count of the people exiting the front region through the interlock is carried out by the interlock,
a number of people within the front region is determined and/or monitored by the count and the further count.

13. A method for controlling a flow of people and/or for security screening by an interlock comprising an entrance and an inner region arranged behind the entrance, wherein the interlock has a body scanner and an optical playback device, wherein the body scanner is configured to scan a body of a person in the inner region of the interlock and wherein the playback device is configured to display a scanning position of the person, wherein the scanning position is suitable for successfully scanning the body of the person or by a system according to claim 11,
wherein the method includes the following steps in the following order:
displaying of the scanning position, and
scanning a body of the person in the inner region of the interlock by the body scanner.

14. The method according to claim 13,
wherein the display of the scanning position by the playback device and the scan of the body by the body scanner are carried out indirectly and/or directly one after the other and/or at least partially simultaneously.

15. A computer program product, wherein the computer program product comprises commands which, when the computer program product is executed by a computer, cause the computer to carry out a method according to claim 13.
